(19) United States
(12) Patent Application Publication
(10) Pub. No.: US 2008/0154693 A1
(43) Pub. Date: Jun. 26, 2008

(54) METHODS AND SYSTEMS FOR FORECASTING PRODUCT DEMAND USING A CAUSAL METHODOLOGY

(76) Inventors: Arash Bateni, Toronto (CA); Edward Kim, Toronto, CA (US); Philip Liew, Markham (CA); Jean-Philippe Vorsanger, Toronto (CA)

Correspondence Address: JAMES M. STOVER;TERADATA CORPORATION, 2835 MIAMI VILLAGE DRIVE, MIAMISBURG, OH, 45342, US

(21) Appl. No.: 11/613,404

(22) Filed: Dec. 20, 2006

(51) Int. Cl. G06Q 10/00

(52) U.S. Cl. 705/10

(57) ABSTRACT

An improved method for forecasting and modeling product demand for a product. The forecasting methodology employs a causal methodology, based on multiple regression techniques, to model the effects of various factors on product demand, and hence better forecast future patterns and trends, improving the efficiency and reliability of the inventory management systems. The demand forecasting technique seeks to establish a cause-effect relationship between product demand and factors influencing product demand in a market environment. Such factors may include current and recent product sales rates, seasonality of demand, product price changes, promotional activities, weather forecasts, competitive information are examples of the other primary factors which can be modeled. A product demand forecast is generated by blending the various influencing factors in accordance with corresponding regression coefficients determined through the analysis of historical product demand and factor information.

### FIELD OF THE INVENTION

The present invention relates to methods and systems for forecasting product demand for retail operations, and in particular to the forecasting of future product demand for products experiencing price changes.

### BACKGROUND OF THE INVENTION

Accurately determining demand forecasts for products are paramount concerns for retail organizations. Demand forecasts are used for inventory control, purchase planning, work force planning, and other planning needs of organizations. Inaccurate demand forecasts can result in shortages of inventory that are needed to meet current demand, which can result in lost sales and revenues for the organizations. Conversely, inventory that exceeds a current demand can adversely impact the profits of an organization. Excessive inventory of perishable goods may lead to a loss for those goods.

Teradata, a division of NCR Corporation, has developed a suite of analytical applications for the retail business, referred to as Teradata Demand Chain Management (DCM), that provides retailers with the tools they need for product demand forecasting, planning and replenishment. Teradata Demand Chain Management assists retailers in accurately forecasting product sales at the store/SKU (Stock Keeping Unit) level to ensure high customer service levels are met, and inventory stock at the store level is optimized and automatically replenished. Teradata DCM helps retailers anticipate increased demand for products and plan for customer promotions by providing the tools to do effective product forecasting through a responsive supply chain.

As illustrated in FIG. 1, the Teradata Demand Chain Management analytical application suite 101 is shown to be part of a data warehouse solution for the retail industries built upon NCR Corporation's Teradata Data Warehouse 103, using a Teradata Retail Logical Data Model (RLDM) 105. The key modules contained within the Teradata Demand Chain Management application suite 101, are:

Contribution: Contribution module 111 provides an automatic categorization of SKUs, merchandise categories and locations based on their contribution to the success of the business. These rankings are used by the replenishment system to ensure the service levels, replenishment rules and space allocation are constantly favoring those items preferred by the customer.

Seasonal Profile: The Seasonal Profile module 112 automatically calculates seasonal selling patterns at all levels of merchandise and location. This module draws on historical sales data to automatically create seasonal models for groups of items with similar seasonal patterns. The model might contain the effects of promotions, markdowns, and items with different seasonal tendencies.

Demand Forecasting: The Demand Forecasting module 113 provides store/SKU level forecasting that responds to unique local customer demand. This module considers both an item's seasonality and its rate of sales (sales trend) to generate an accurate forecast. The module continually compares historical and current demand data and utilizes several methods to determine the best product demand forecast.

Promotions Management: The Promotions Management module 114 automatically calculates the precise additional stock needed to meet demand resulting from promotional activity.

Automated Replenishment: Automated Replenishment module 115 provides the retailer with the ability to manage replenishment both at the distribution center and the store levels. The module provides suggested order quantities based on business policies, service levels, forecast error, risk stock, review times, and lead times.

Time Phased Replenishment: Time Phased Replenishment module 116 Provides a weekly long-range order forecast that can be shared with vendors to facilitate collaborative planning and order execution. Logistical and ordering constraints such as lead times, review times, service-level targets, min/max shelf levels, etc. can be simulated to improve the synchronization of ordering with individual store requirements.

Allocation: The Allocation module 115 uses intelligent forecasting methods to manage pre-allocation, purchase order and distribution center on-hand allocation.

Load Builder: Load Builder module 118 optimizes the inventory deliveries coming from the distribution centers (DCs) and going to the retailer's stores. It enables the retailer to review and optimize planned loads.

Capacity Planning: Capacity Planning module 119 looks at the available throughput of a retailer's supply chain to identify when available capacity will be exceeded.

Accurate demand forecast is a key parameter for various business activities, particularly inventory control and replenishment, and hence it significantly contributes to the firms' productivity and profit. The Teradata Demand Chain Management suite of products described above employs time series analysis, sequential decomposition of effects and projection techniques to forecast future demand. This approach, as well as other traditional forecasting methods, essentially relies on past sales data and has limited accuracy when product demand is driven by various causal factors such as price change, promotional activities, competitors' activities or the weather. The discussion which follows introduces a causal methodology, based on multiple regression techniques, which can model the effects of various factors on demand, and hence better forecast future patterns and trends, thereby improving the efficiency and reliability of the inventory management systems and ultimately improve the profitability of the clients.

### BRIEF DESCRIPTION OF THE DRAWINGS

FIG. 1 provides an illustration of a forecasting, planning and replenishment software application suite for the retail industries built upon NCR Corporation's Teradata Data Warehouse.

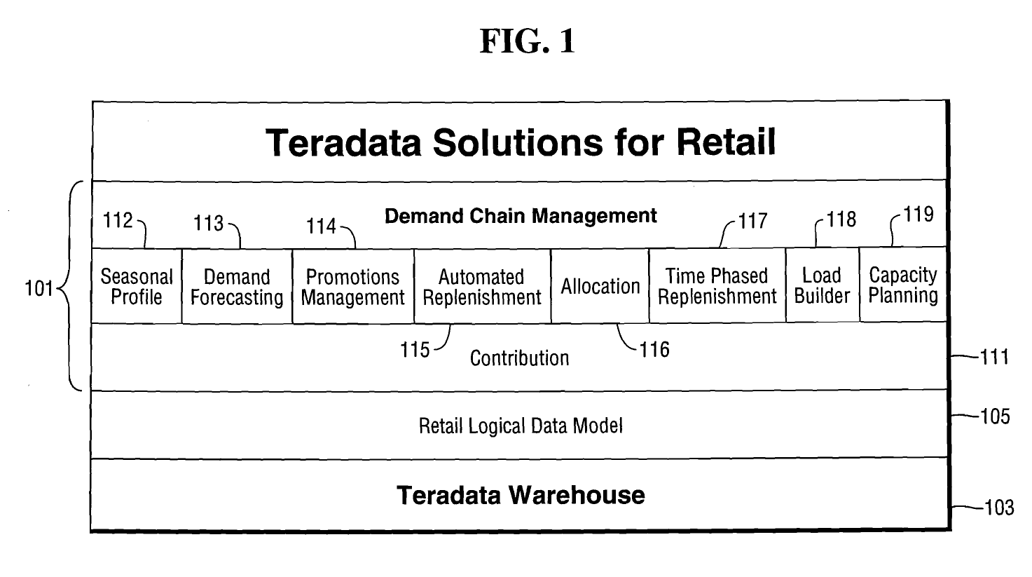

FIG. 2 provides a scatter plot showing numerous weekly demand levels for a product at various product unit prices.

FIG. 3 is a flow chart illustrating a method for determining product demand forecasts in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

The Teradata Demand Chain Management suites of products, as discussed above, models historical sales data to forecast future demand of products. The method currently employed consists of seasonal adjustment of the historical sales patterns and extrapolation of demand using exponential moving average. This approach, called projection, generally neglects the causes of the historical sales patterns and relies on the assumption that the future is the continuation of the past.

The demand forecasting technique described herein, referred to as a causal approach to demand forecasting, seeks to establish a cause-effect relationship between demand and the influencing factors in market environment. A clear example of such factors is the seasonality of demand, which is included in the current systems. Price changes, promotional activities, weather forecasts, competitive information are examples of the other primary factors which can be modeled. Another characteristic of the causal factors are that they are inputs to the forecast model whose future values are known, or may be predicted accurately.

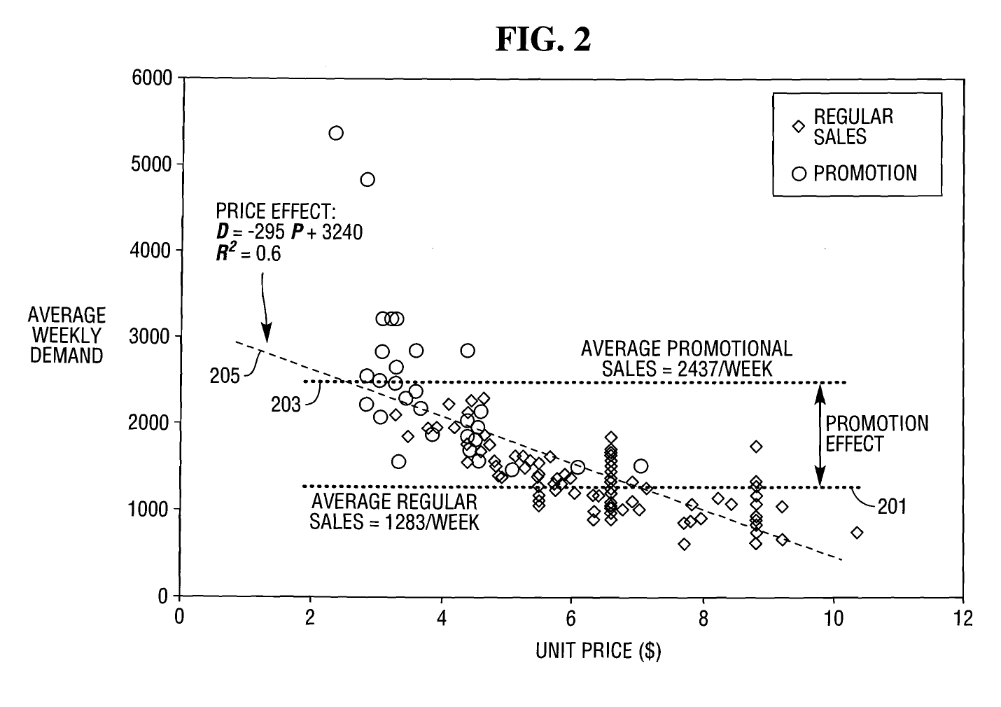

As an illustration, FIG. 2 provides a scatter plot of weekly demand versus price of an actual product, with data extracted from years 2002 through 2004. Weekly demand values for the regular priced product are represented by diamonds (⋄) in the scatter plot. Weekly demand values for the promotional priced product are represented by circles (∘) in the scatter plot. Horizontal lines 201 and 203 identify average regular and average promotional weekly sales, respectively.

Two different causal effects can be seen in the plot illustrated in FIG. 2: the price effect and the promotion effect. The price effect is described by the overall decrease in demand with increasing the unit price. Dashed line 205 is a fitted regression line based upon the product price and demand data. The negative slope of line 205 indicates a negative correlation of product price with product demand, known as price elasticity of demand. The promotion effect is identified by comparing regular and promotional sales, i.e., the difference in average regular and average promotional weekly sales represented by lines 201 and 203, respectiely. FIG. 2 shows a significant shift in demand due to promotions.

In the absence of a causal methodology, the above effects would appear as noise or undescribed scatter, and hence contribute to forecast error. Such errors can be avoided by understanding and modeling the effect of each of these factors on the product demand. This is a sophisticated practice, however, due to the correlation or dependency of the causal factors. For instance, promotional sales often coincide with lower unit price and both partly contribute to a demand increase. Therefore, the price and promotion effects as calculated in FIG. 2 are not additive. Furthermore, traditional techniques for time series analysis, such as sequential decomposing of effects, cannot be employed for this purpose. Techniques for time series analysis are described in “The Analysis of Time Series, An Introduction,” 5^{th} Edition, 1999, by Chris Chatfield, Chapman & Hall/CRC, ISBN 0-412-71649-2.

In view of the above shortcomings, a methodology is presented herein that simultaneously calculates and models the partial role of various casual factors on the demand.

### Description of Methodology

A multiple regression model was developed to model the effect of multiple causal factors, and from which forecast the demand. The regression equation is defined as

D=α.D₋₁+β.D₂+γ.D₋₅₂+λ.PRICE+δ.PROMO+η. EQN1

The above equation, EQN1, incorporates a number of advanced features of regression. The first three terms on the right hand side of the equation model the autocorrelation of demand, where the first, second and 52^{nd} lags of the weekly demand (D₋₁, D₋₂ and D₋₅₂, respectively) are used as regression variables. The first two terms model the recent trend and patterns of the demand, and the third term, 52^{nd} lag, models the demand seasonality. The fourth term of the regression equation models the price driven demand, where ? (lamda) is the price elasticity coefficient. The fifth term is a categorical regression term that models the uplift of demand due to a promotion. Note, a promotional activity may or may not be accompanied by a price discount. The label or categorical variable PROMO (=0 or 1) marks the promotion weeks and d (delta) is the additive uplift. Detailed information about the regression techniques used in this model can be found in “Statistics for Managers,” 1995, by Ulrich Menzefricke, Wadsworth Publshing Company, ISBN 0-534-23538-7.

The above model calculates the regression coefficients (α, β, . . . ?) using historical sales, price and promotion data. A product demand forecast can thereafter be determined based on the information about future price and promotion strategies. Various statistical tests are performed to evaluate the significance of the above model for a given set of data (e.g. F-test, P-value evaluation and R²). Furthermore, the significance of each casual factor is evaluated using a statistical t-test. A factor is removed from the model if no significant cause-effect relationship is identified. Similarly, other casual factors, such as weather or competition activities, can be added to the model if a significant effect is identified.

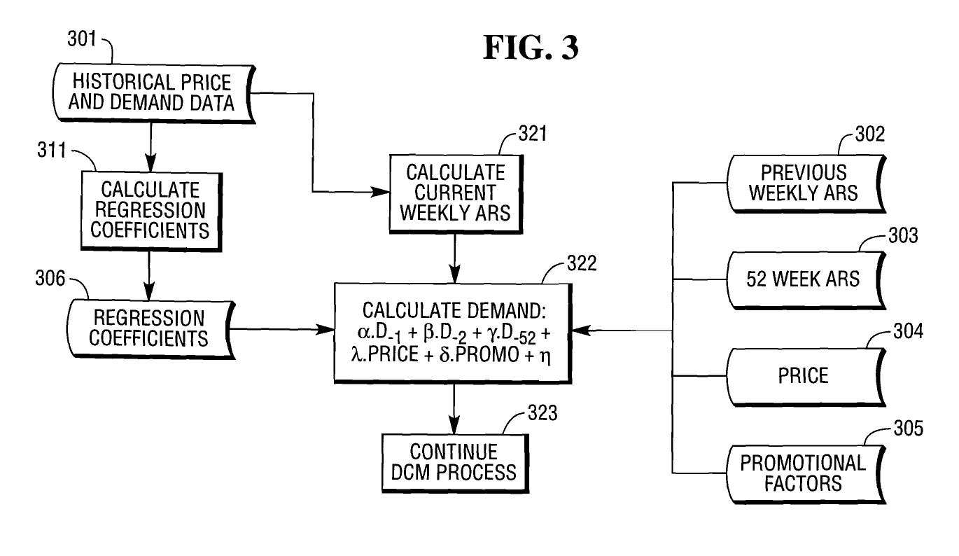

FIG. 3 is a flow chart illustrating a casual method for estimating product demand at weekly intervals. As part of the DCM demand forecasting process, historical price and demand data 301 is saved for each product or service offered by a retailer. The DCM system also determines and saves previous weekly ARS and 52-week ARS data, 302 and 303, respectively; price data 304; and promotional factors 305. Methods for determining price driven demand data are described in United States Patent Application titled “IMPROVED METHODS AND SYSTEMS FOR FORECASTING PRODUCT DEMAND USING PRICE ELASTICITY” by Arash Bateni, Edward Kim, Philip Liew and J. P. Vorsanger, filed on Dec. 4, 2006, and assigned to NCR Corporation.

In step 311, regression coefficients (α, β, . . . ?) are calculated using historical sales, price and promotion data 301. Results are saved as data 306. This calculation may be run weekly to update the coefficients as new sales data becomes available. This strategy maximizes the accuracy of the method, since it uses all the available data. However, when the computational efficiency is of a concern, the coefficients can be updated less frequently.

In step 321 of FIG. 3, the current weekly ARS for a product is calculated from historical demand data 301. In step 322, the product demand forecast is determined by blending the Average Rate of Sales (ARS) from step 321 with the second and 52^{nd} lags of the weekly demand from data stores 302 and 303, respectively, the price from data store 304, and promotional factors from data store 305. The current ARS, previous weekly ARS, 53-week ARS, price driven demand, and promotional factors are blended in accordance with EQN1, with the regression coefficients (α, β, . . . ?) calculated in step 311. Although separate data stores are indicated by reference numerals 301 through 306, the stored data may be saved in a single storage device or database.

At step 323, the DCM forecasting process continues, using product demand forecast values determined in step 322

### Conclusion

The Figures and description of the invention provided above reveal a novel system utilizing a causal methodology, based on multiple regression techniques, to model the effects of various factors on product demand, and hence better forecast future patterns and trends, improving the efficiency and reliability of the inventory management systems.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A method for forecasting product demand for a product, the method comprising the steps of:
maintaining a database of historical product demand information;
identifying a plurality of factors influencing demand for said product;
analyzing said historical product demand information for said product to determine a plurality of regression coefficients corresponding to said plurality of factors;
blending said plurality of regression coefficients and corresponding plurality of factors for said product to determine a product demand forecast for said product.

2. The method for forecasting product demand for a product in accordance with claim 1, wherein said database of historical product demand information includes information concerning product demand, product pricing, and product promotions.

3. The method for forecasting product demand for a product in accordance with claim 2, wherein said plurality of factors includes:
an average rate of sale (ARS) value for said product calculated for a current weekly forecast period;
a previous average rate of sale (ARS) value for said product calculated for a weekly forecast period preceding said current weekly forecast period;
a long term average rate of sale (ARS) value for said product; and
a price driven demand value for said product specifying a relationship between the price of said product and the demand for said product.

4. The method for forecasting product demand for a product in accordance with claim 3, wherein said plurality of factors further includes:
a promotional factor value for said product specifying a relationship between promotions for said product and the demand for said product.

5. The method for forecasting product demand for a product in accordance with claim 2, wherein said step of blending said plurality of regression coefficients and corresponding plurality of factors for said product to determine a product demand forecast for said product comprises the step of:
determining said product demand forecast (D) in accordance with the equation: D=α.D₋₁+β.D₋₂+γ.D₋₅₂+λ.PRICE+δ.PROMO+η, where:
D₋₁ is an average rate of sale (ARS) value for said product calculated for a current weekly forecast period;
D₋₂ is a previous average rate of sale (ARS) value for said product calculated for a weekly forecast period preceding said current weekly forecast period;
D₋₅₂ a long term average rate of sale (ARS) value for said product;
PRICE is a price driven demand value for said product specifying a relationship between the price of said product and the demand for said product;
PROMO is a promotional factor value for said product specifying a relationship between promotions for said product and the demand for said product; and
α, β, ?, ?, and d are regression coefficients corresponding to factors D₋₁, D₋₂, D₋₅₂, PRICE, and PROMO, respectively, which determine the relative importance of said factors in determining a product demand forecast for said product.

6. A method for forecasting product demand for a product, the method comprising the steps of:
maintaining a database of historical product demand information;
determining at weekly intervals a current weekly average rate of sale (ARS) and a 52 week average rate of sale (ARS) for said product from said historical product demand information;
analyzing said historical product demand information for said product to determine a price driven demand value for said product specifying a relationship between the price of said product and the demand for said product.
analyzing said historical product demand information for said product to determine a promotional factor value for said product specifying a relationship between promotions for said product and the demand for said product; and
determining said product demand forecast (D) in accordance with the equation: D=α.D₋₁+β.D₋₂+γ.D₋₅₂+λ.PRICE+δ.PROMO+η, where:
D₋₁ is an average rate of sale (ARS) value for said product calculated for a current weekly forecast period;
D₋₂ is a previous average rate of sale (ARS) value for said product calculated for a weekly forecast period preceding said current weekly forecast period;
D₋₅₂ a long term average rate of sale (ARS) value for said product;
PRICE is a price driven demand value for said product specifying a relationship between the price of said product and the demand for said product;
PROMO is a promotional factor value for said product specifying a relationship between promotions for said product and the demand for said product; and
α, β, ?,?, and d are regression coefficients corresponding to factors D₋₁, D₋₂, D₋₅₂, PRICE, and PROMO, respectively, which determine the relative importance of said factors in determining a product demand forecast for said product.

7. The method for forecasting product demand for a product in accordance with claim 6, further comprising the step of:
analyzing said historical product demand information for said product to determine values for said regression coefficients.
